(19) United States
(12) Patent Application Publication
(10) Pub. No.: US 2010/0192069 A1
(43) Pub. Date: Jul. 29, 2010

(54) Differentiating a User from Multiple Users Based on a Determined Pattern of Accessing a Prescribed Network Destination

(75) Inventors: John TOEBES, Cary, NC (US); Philip Clifford JACOBS, Windham, NH (US); Matthew KUHLKE, San Francisco, CA (US); Guido JOURET, Mountain View, CA (US)

Correspondence Address: LEON R TURKEVICH, 2000 M STREET NW, 7TH FLOOR, WASHINGTON, DC, 200363307, US

(73) Assignee: CISCO TECHNOLOGY, INC., San Jose, CA (US)

(21) Appl. No.: 12/358,504

(22) Filed: Jan. 23, 2009

(51) Int. Cl. G06F 3/00

(52) U.S. Cl. 715/745

(57) ABSTRACT

In one embodiment, a method comprises detecting, by an apparatus at a user premises, a user method executed by a user at the user premises for submitting a web request for an identified web destination, the user method being one of a plurality of available user methods for submitting the web request; associating, by the apparatus, the user method with the identified web destination specified in the web request; and outputting, by the apparatus, the web request with at least one of a user method identifier specifying the corresponding user method or a user identifier that identifies the user independent of any data structure received from any web destination.

### TECHNICAL FIELD

The present disclosure generally relates to distinguishing a user from among multiple users that share a user device at a user premises, for example a personal computer.

### BACKGROUND

Individuals are accustomed to sharing a limited resource at a user premises, for example a personal computer, a remote control of a television, a cable set-top box, etc. Individuals can establish personalized settings on a shared personal computer based on creating a prescribed user identity having an associated user profile within the operating system on the shared personal computer (e.g., Windows XP commercially available from Microsoft Corporation). The user profile is stored in the shared personal computer as a data structure that includes attributes and settings specifically associated with the corresponding user identity. Once an individual has created a user identity, the individual can log into the operating system environment (e.g., an executable instance of the operating system that is stored in computer memory reserved by the operating system) using the corresponding user identity. Once logged into the operating system using his or her user identity, the individual can be identifiable as a “user” based on the corresponding user identity and enjoy personalized user service based on the corresponding user profile that stores personalized settings for various executable applications such as a web browser (e.g., Firefox) (e.g., bookmarks, display settings, security settings, etc.). The user profile for the corresponding user identity also can contain information supplied from external sources, for example websites can store data structures known as “cookies” within the user profile.

Although a personal computer can have multiple user profiles for respective individuals, an individual can enjoy his or her personalized settings only while logged into the operating system environment using his or her corresponding user identity: if a first individual having established a first user identity on the personal computer used the personal computer while the operating system environment presented the user profile of a second user identity assigned to a second individual, the first individual would not have access to the personalized settings established for the first user identity.

### BRIEF DESCRIPTION OF THE DRAWINGS

Reference is made to the attached drawings, wherein elements having the same reference numeral designations represent like elements throughout and wherein:

FIG. 1 illustrates an example system at a user premises enabling identification of a user based on a determined correlation between a user method for submitting a web request for an identified web destination relative to a stored user method for the identified web destination, according to an example embodiment.

FIG. 2 illustrates an example method for enabling identification of the user, according to an example embodiment.

FIG. 3 illustrates an example sequence of network activity initiated by the users of FIG. 1 and detected by the user devices of FIG. 1, according to an example embodiment.

FIG. 4 illustrates an example data structure generated by a user device and/or the user premises router of FIG. 1 and storing network activity entries as user behavior indicators, according to an example embodiment.

FIG. 5 illustrates a second example of the data structure of FIG. 4, indexed according to identified web destinations for identification of a user, according to an example embodiment.

### DESCRIPTION OF EXAMPLE EMBODIMENTS OVERVIEW

In one embodiment, a method comprises detecting, by an apparatus at a user premises, a user method executed by a user at the user premises for submitting a web request for an identified web destination, the user method being one of a plurality of available user methods for submitting the web request; associating, by the apparatus, the user method with the identified web destination specified in the web request; and outputting, by the apparatus, the web request with at least one of a user method identifier specifying the corresponding user method or a user identifier that identifies the user independent of any data structure received from any web destination.

In another embodiment, an apparatus comprises a device interface circuit and a processor circuit. The device interface circuit is configured for detecting a user input associated with a user method executed by a user at a user premises for submitting a web request for an identified web destination, the user method being one of a plurality of available user methods for submitting the web request. The processor circuit is configured for associating the user method with the identified web destination specified in the web request. The processor circuit further is configured for outputting, via the device interface circuit, the web request with at least one of a user method identifier specifying the corresponding user method or a user identifier that identifies the user independent of any data structure received from any web destination, the apparatus implemented at the user premises.

### DETAILED DESCRIPTION

Particular embodiments disclosed herein can distinguish between users that are interacting with a shared user device at a user premises (e.g., during respective user access sessions) without the necessity of the users logging in or otherwise identifying themselves, and independent of any data structure received from any web destination (e.g., “cookies”). The particular embodiments can distinguish between users based on distinguishing methods by users toward accessing the same identified web destination.

In particular, different users may access a given identified web destination (e.g., a website reachable via the Internet) via different user methods: one user may tend to access a given website based on executing a manual text entry of at least a portion of a Uniform Resource Locator (URL) string; another user may access the same website based on retrieval of the identified web destination (e.g., URL) from a data structure stored on the user device, for example a “bookmark” file configured for storing “bookmarks” that specify a web page name and a corresponding URL; still another user may access the same website based on selecting the corresponding URL from a web page presented to the user by the user device.

Individuals tend to form repeatable patterns (i.e., habits) with respect to the user method executed for submitting a web request for an identified web destination. Hence, the detection of the user method executed by a given user for submitting a web request for an identified web destination, in combination with associating the user method with the actual identified web destination specified in the web request, enables the storage of the identified web destination with the corresponding user method in the form of a user behavior indicator of the user toward the identified web destination.

A given user may have a habit of executing different user methods for submitting web requests for different web destinations. A user may use one user method for accessing a first web destination, a second user method for accessing a second web destination, and still a third user method for accessing a third web destination. Hence, user behavior indicators by the user toward respective identified web destinations can be accumulated as part of a “training” operation. The accumulation of multiple user behavior indicators (identifying user methods executed by the user toward respective identified web destinations) establishes a determined behavior pattern by the user toward respective identified web destinations. Similarly, the identification of a distinct user access session enables establishment of a second determined behavior pattern by a second user toward the respective identified web destinations accessed by the second user during the distinct user access session.

The particular embodiments disclosed herein can distinguish between the users based on comparing a detected user method toward an identified web destination with at least one stored user method toward the identified web destination and assigned to an identified user. The user having supplied the web request according to the detected user method can be distinguished from other users based on a determined correlation between the detected user method and a corresponding stored user method, where the stored user method is for the identified web destination and is assigned to the identified user based on the corresponding determined behavior pattern.

Hence, the particular embodiments enable identifying a user as distinct from a second user based on distinguishing between distinct user methods for submitting a web request for an identified web destination, enabling user identification for personalized web services without the necessity of any data structures generated or received from any web destination (e.g., cookies), and without the necessity of any login procedure by the user into the user device or a website.

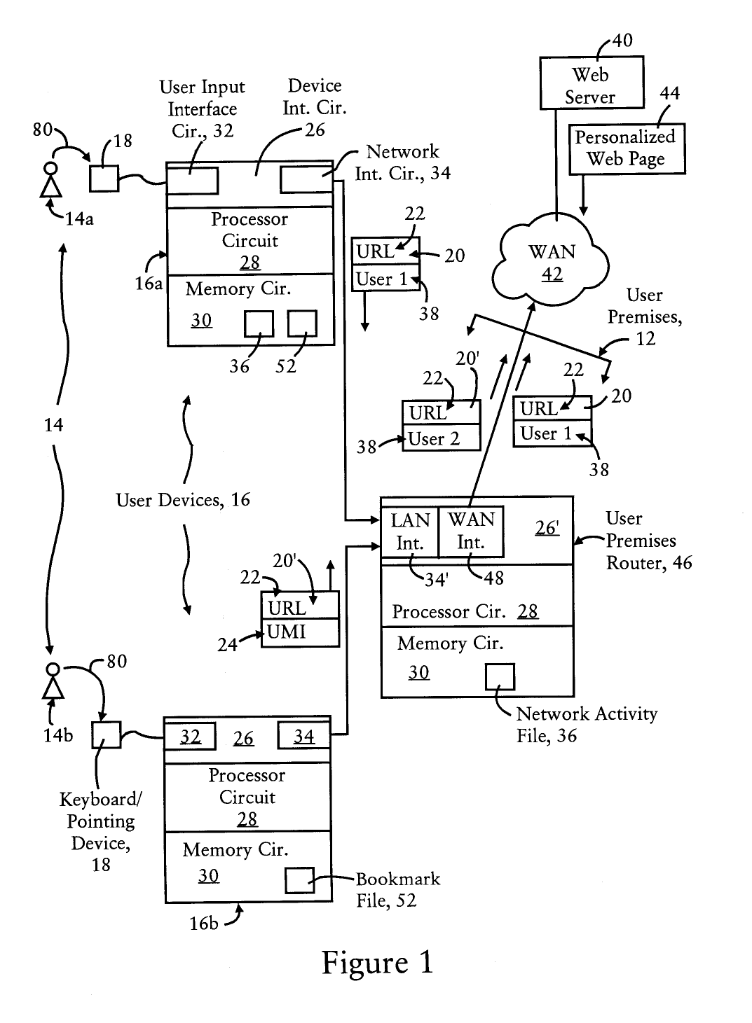

FIG. 1 illustrates an example system 10 at a user premises 12 enabling identification of a user 14 based on a determined correlation between a determined user method for submitting a web request 20 for an identified web destination relative to a stored user method for the same identified web destination, according to an example embodiment. The web request 20 can be implemented, for example, as a hypertext transport protocol (HTTP) GET request that identifies an identified web destination in the form of a Uniform Resource Identifier (URI) or a Uniform Resource Locator (URL). The users 14a and 14b can either share a single network-enabled user device (i.e., network-enabled user machine or network-enabled user apparatus) 16, or interact with their respective user devices 16a and 16b. As illustrated in FIG. 1, the user device 16a outputs a web request 20 specifying an identified URL 22, and the user device 16b outputs a web request 20′ specifying the same URL 22.

Each of the user devices 16a and 16b is a network-enabled machine that includes a device interface circuit 26, a processor circuit 28, and a memory circuit 30. Each of the device interface circuits 26 in the user devices 16 includes a user input interface circuit 32 configured for detecting user inputs 80 supplied by the respective users 14a and 14b via user input circuitry 18 (e.g., a keyboard and/or pointing device such as a trackball, mouse, touchpad, etc.), and a network interface circuit (e.g., IEEE 802.3 or IEEE 802.11 network interface circuit) 34 configured for outputting any web request 20 or 20′ generated by the corresponding user 14 toward the identified web destination (e.g., web server 40) according to Internet protocol. The processor circuit 28 in each of the user devices 16 is configured for detecting the user method executed by the corresponding user 14 for submitting the web request 20 or 20′. Hence, the processor circuit 28 in each of the user devices 16a and 16b can associate the user method executed by the corresponding user 14a and 14b with the identified web destination (e.g., a specific URL) 22 specified in the request 20 or 20′, and generate a corresponding user method identifier (UMI) 24 specifying the user method executed by the corresponding user 14 for submitting the corresponding web request 20 or 20′.

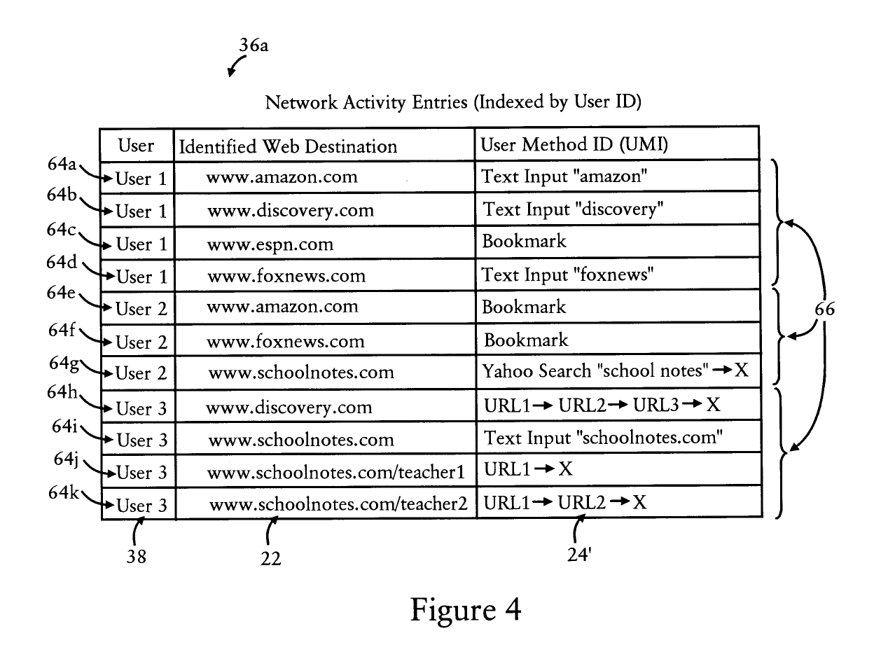

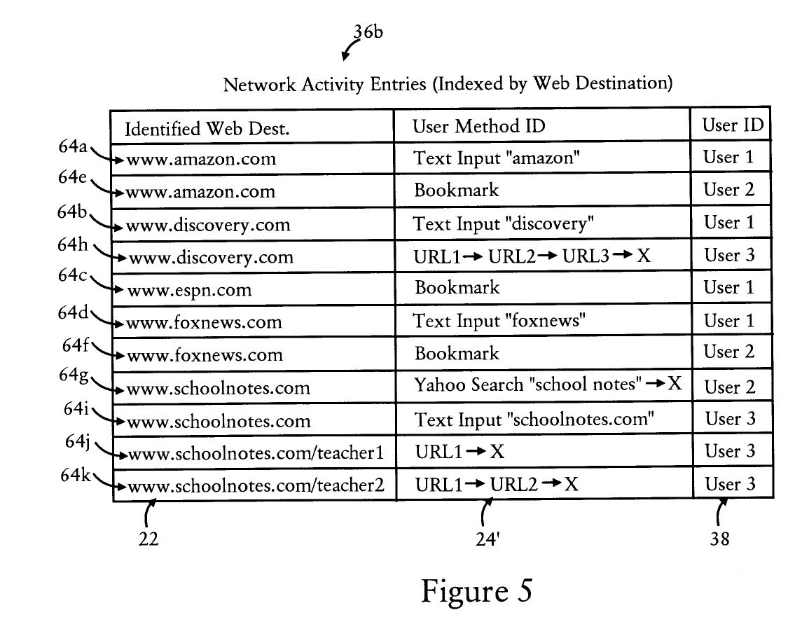

The processor circuit 28 in each user device (e.g., 16a) can store the web request 20 or 20′ for the identified destination 22 with the corresponding user method identifier 24 within the corresponding memory circuit 30 as a network activity entry within a network activity file 36, described in further detail below with respect to FIGS. 4 and 5. As described in further detail below, the processor circuit 28 in the user device 16a can identify a user 14 (e.g., 14a) as distinct from another user (e.g., 14b) having previously used the user device 16a. The processor circuit 28 in the user device 16a can identify the user 14a based on a determined correlation between the user method executed by the current user 14a for requesting the identified web destination 22, and a corresponding stored user method in the network activity file 36 for the identified web destination 22 and assigned to the user 14a. Hence, in response to the processor circuit 28 in the user device 16a identifying the user 14a, the processor circuit 28 can output, via the network interface circuit 34, the web request 20 with a corresponding user identifier 38 that identifies the user 14a (e.g., “User 1”).

Consequently, the user device 16a can output to a destination web server 40, for example via a wide area network 42, the web request 20 specifying the identified web destination 22 with the user identifier 38 that identifies the user 14a independent of any data structure (e.g., “cookie”) received from any web destination such as the web server 14, and independent of any login procedure by the user 14a into the user device 16b or the web server 40. Hence, the web server 40 can respond to the web request 20 and the user identifier 38 identifying “User 1” by providing a personalized web page 44 for “User 1”, for example based on retrieval of user attributes from server-side data structures, or based on generating a personalized list of recommended content for the identified user “User 1”, without the necessity of any “cookie” or any login procedure by the user 14a.

The identification of a user also can be performed by a network device (i.e., network machine or network apparatus) 46 implemented at the user premises 12 and that is distinct from the user devices 14, for example a commercially available Linksys® router that is modified as described herein. The network machine 46 can implement network communications in an Internet Protocol (IP) based network between one or more user devices 16 and/or the web server device 40 (e.g., via the wide area network 42). Hence, the identification of the user still can be completed if a user device (e.g., 16b) is not configured for executing the identification of the user as described above with respect to the user device 16a. In this example, the processor circuit 28 of the user device 16b can detect the user method executed by the user 14b for submitting the web request 20′ for the identified web destination 22 in response to the associated user inputs 80 supplied by the user 14b via the user input circuitry 18. The processor circuit 28 of the user device 16b also can associate the user method with the identified web destination 22, and generate a user method identifier 24 that specifies the corresponding user method. The processor circuit 28 of the user device 16b also can output the web request 20′ with the corresponding user method identifier 24 via the corresponding network interface circuit 34 to the user premises router 46, for collection by the user premises router 46 of the user behavior indicator of the user 14b toward the identified destination 22.

As illustrated in FIG. 1, the user premises router 46 includes a device interface circuit 26′, a processor circuit 28, and a memory circuit 30. The device interface circuit 26′ includes a local area network interface circuit (LAN) 34′ for establishing wired or wireless link layer communications with the respective network interface circuits 34 (e.g., including wired IEEE 802.3 10/100 Mbit/s network interface ports and a wireless IEEE 802.11 network interface circuit), and a wide area network (WAN) network interface circuit 48 (e.g., a wired IEEE 802.3 100/1000 Mbit/s network interface port) for establishing a data link with an access router in the wide area network 42.

Hence, the processor circuit 28 in the user premises router 46 can detect the user method executed by the user 14b in response to the local area network interface 34′ receiving the web request 20′ and the corresponding user method identifier 24 from the user device 16b having generated the user method identifier 24 relative to the web request 20′. The processor circuit 28 in the user premises router 46 can associate the user method specified in the user method identifier 24 with the identified web destination 22 based on storing the identified destination 22 and the corresponding user method identifier 24 within a network activity entry of a network activity file 36 stored in the corresponding memory circuit 30 of the user premises router 46.

The processor circuit 28 in the user premises router 46 can accumulate in the network activity file 36 multiple web requests 20′ with respective user method identifiers 24 in respective network activity entries, enabling identification by the processor circuit 28 of a determined behavior pattern toward respective identified web destinations by the user 14b. As described above with respect to the user device 16a, the processor circuit 28 in the user premises router 46 also can identify the behavior pattern of the user 14a, for example based on the processor circuit 28 of the user device 16a forwarding its network activity file 36 to the user premises router 46. The processor circuits 28 of the user premises router 46 and the user device 16a also can synchronize their respective network activity files 36, enabling both the user premises router 46 and the user device 16a to share the accumulation of the network activity entries for establishment of the behavior patterns for the users 14a and 14b.

Hence, the user device 16a and the user premises router 46 each can independently identify a user of a user device 16, for example being able to distinguish whether user 14a or 14b is using either user device 16a or 16b.

Any of the disclosed circuits of a user device 16 and/or the user premises router 46 (including the device interface circuit 26 or 26′, the processor circuit 28, the memory circuit 30, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown), where execution of executable code stored in an internal memory circuit (e.g., within the memory circuit 30) causes the processor circuit to store application state variables in processor memory, creating an executable application resource (e.g., an application instance) that performs the operations of the circuit as described herein. Hence, use of the term “circuit” in this specification refers to both a hardware-based circuit that includes logic for performing the described operations, or a software-based circuit that includes a reserved portion of processor memory for storage of application state data and application variables that are modified by execution of the executable code by a processor circuit. The memory circuit 30 can be implemented, for example, using a non-volatile memory such as a programmable read only memory (PROM) or an EPROM, and/or a volatile memory such as a DRAM, etc.

Further, any reference to “outputting a data structure” (or the like) can be implemented based on storing that data structure in a tangible memory medium in the disclosed apparatus (e.g., in the memory circuit 30 or a transmit buffer in the network interface circuit 34, 34′ or 48). Any reference to “outputting a data structure” (or the like) also can include electrically transmitting (e.g., via wired electric current or wireless electric field, as appropriate) the data structure stored in the tangible memory medium to another network node via a communications medium (e.g., a wired or wireless link, as appropriate) (optical transmission also can be used, as appropriate). Similarly, any reference to “receiving a data structure” (or the like) can be implemented based on the disclosed apparatus detecting the electrical (or optical) transmission of the data structure on the communications medium, and storing the detected transmission of the data structure in a tangible memory medium in the disclosed apparatus (e.g., in a receive buffer). Also note that the memory circuit 30 can be implemented dynamically by the processor circuit 28, for example based on memory address assignment and partitioning executed by the processor circuit 28.

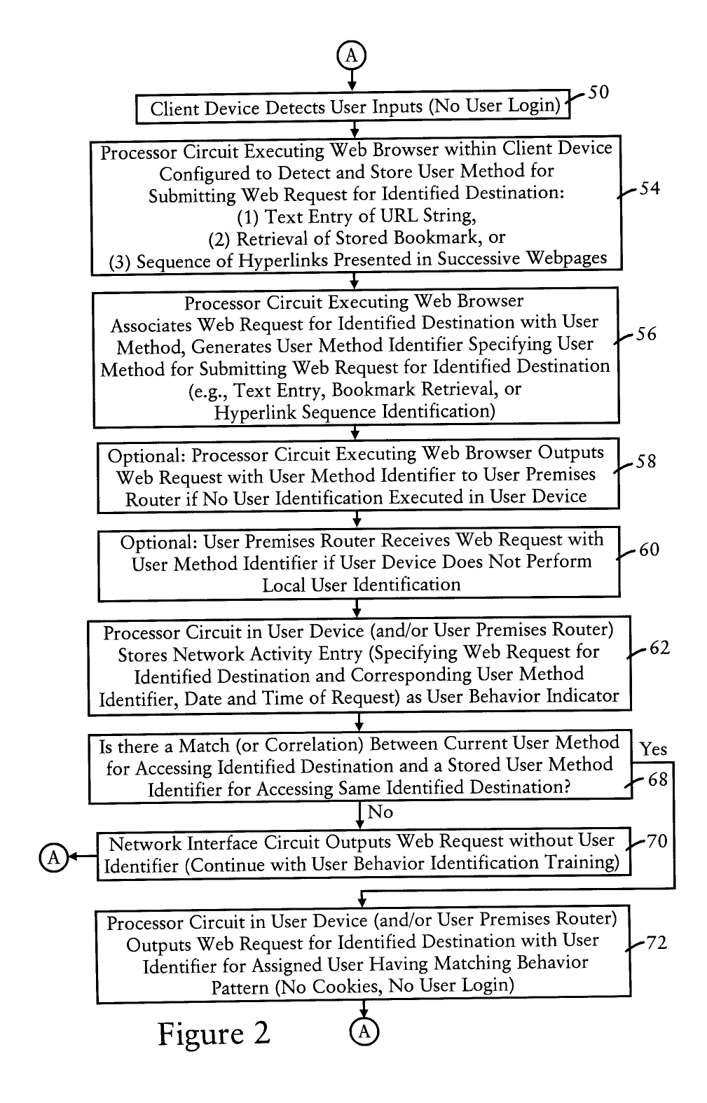

FIG. 2 illustrates an example method for enabling identification of the user, according to an example embodiment. The steps described in FIG. 2 can be implemented as executable code stored on a computer readable storage medium (e.g., floppy disk, hard disk, ROM, EEPROM, nonvolatile RAM, CD-ROM, etc.) that are completed based on execution of the code by a processor circuit; the steps described herein also can be implemented as executable logic that is encoded in one or more tangible media for execution (e.g., programmable logic arrays or devices, field programmable gate arrays, programmable array logic, application specific integrated circuits, etc.).

The steps described with respect to FIG. 2 can be executed solely by the user device 16a, including identifying the user (e.g., 14a) as distinct from a second user (e.g., 14b), based on a determined correlation between the user method executed by the user of the user device 16a (e.g., 14a) for an identified web destination, and a stored network activity entry assigned to the user (e.g., 14a) and that specifies the corresponding stored user method for the identified web destination.

The steps described with respect to FIG. 2 also can be executed based on a user device (e.g., 16b) detecting the user inputs associated with the user method executed by the user (e.g., 16b) and generating a user method identifier 24 that specifies the corresponding user method for submitting the web request 20′ for the identified web destination 22. Hence, the user premises router 46 can identify the user of the user device (e.g., 16b) based on receiving the user method identifier 24 with the web request 20′.

As illustrated in FIG. 2, each user device 16 (e.g., 16a, 16b) in step 50 can detect user inputs 80 that are supplied by a corresponding user (e.g., 14a, 14b) 14 in association with submitting a web request 20 or 20′ for an identified web destination 22, without the necessity of the user 14 performing any user login procedure with respect to the user device 16 (e.g., an operating system login procedure, etc.). In particular, the processor circuit 28 in each user device 16 is configured for detecting user inputs 80 as a web request during execution of a web browser. The processor circuit 28 of a user device 16 can detect, during execution of the corresponding instance of the web browser, that the user input is associated with submitting a web request according to a specific user method, depending on the type of user input that is supplied by the user. For example, the processor circuit 28 can detect execution of a user method in the form of a text-based entry of a URL string, where a user manually enters the URL (e.g., “www.amazon.com”) using a keyboard or a speech to text resource executed by the processor circuit 28 within the context of the execution of the web browser. The processor circuit 28 also can detect, during execution of the web browser, execution of a user method in the form of the user retrieving a stored bookmark that is stored in a local data structure 52 (illustrated in FIG. 1 as a “bookmark file”), where the stored bookmark specifies at least the URL 22 of the identified web destination. The processor circuit 28 also can detect, during execution of the web browser, execution of a user method in executing a web request based on the user selecting the identified web destination from a web page presented by the user device (e.g., the user clicking on a hyperlink presented within the web page displayed by the user device 16).

As illustrated with respect to step 54, the processor circuit 28 within the user device 16 that executes the web browser also is configured to detect and store the user method that is executed by the user 14 for submitting the web request 20 for the identified destination 22. The user method can be any one numerous available user methods, including text entry of a URL string, a retrieval of a stored bookmark from a bookmark file 52, or user selection of a contiguous sequence of hyperlinks representing respective web pages that are requested in sequence by the user. Hence, in response to the processor circuit 28 detecting the user input 80 within the context of a web browser window that is presented to the user 14 in response to execution of a web browser by the processor circuit 28, the processor circuit 28 within the user device 16 not only generates the web request 20 or 20′ for the identified web destination 22, but also associates the web request 20 with the corresponding detected user method used for submitting the web request 20. The processor circuit 28 generates in step 56 a user method identifier 24 that specifies the detected user method, for example the text entry that was input as at least part of the URL string, an indicator that the user retrieved a stored bookmark (e.g., from a bookmark file 52), or a sequence of hyperlinks that were presented to the user 14 in successive web pages.

In the example where a user device (e.g., 16b) is not configured for performing user identification, or if the user premises router 46 is to be configured for performing the user identification, the processor circuit 28 executing the web browser can output in step 58 the web request 20′ with the user method identifier 24 to the user premises router 46, as illustrated with respect to the user device 16b of FIG. 1, enabling the user premises router 46 in step 60 to detect the user method executed by the user for submitting the corresponding web request 20 in response to the processor circuit 28 in the router 46 receiving the web request 20 and corresponding user method identifier 24 via the corresponding network interface circuit 34′.

Hence, depending on implementation, the processor circuit 28 in the user device (e.g., 16a) and/or the processor circuit 28 in the user premises router 46 can store in step 62 a network activity entry as a user behavior indicator, illustrated in further detail with respect to FIG. 4.

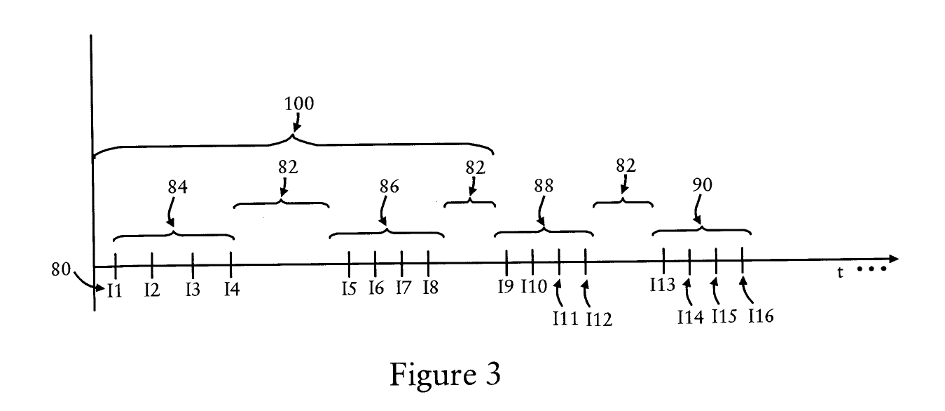

FIG. 4 illustrates an example network activity file 36a storing network activity entries 64, each network activity entry 64 representing a corresponding user behavior indicator by an identified user 14 toward an identified destination 22. In particular, each network activity entry 64 identifies a user behavior by an identified user toward an identified web destination 22 based on a stored user method identifier 24′ that was initially generated by the user device 16. The collection of network activity entries 64 toward different web destinations 22 by the same user (e.g., 14a) is identified as a determined behavior pattern 66 toward respective identified web destinations 22 by the user 14. As described in further detail with respect to FIG. 3, each network activity entry 64 can be assigned to a specific user 14, having a corresponding identifier (e.g., “User 1”, “User 2”, “User 3”) 38, based on the processor circuit 28 associating the corresponding network activity entry 64 relative to a user access session. In other words, each network activity entry 64 can be assigned to a user 14 based on detecting a pattern of repeatable user behaviors that distinguish the user from other users. This association is performed by the processor circuit 28 as part of a “training interval”, described below with respect to FIG. 3.

The processor circuit 28 of the user device (e.g., 16a) and/or the user premises router 46 determines in step 68 of FIG. 2 whether there are sufficient network activity entries 64 that enable users to be distinguished based on their respective user methods for submitting a web request 22, for example following a sufficient “training interval”. As illustrated in FIG. 5, the network activity entries 64 in the network activity file 36b can be indexed by web destination 22, enabling users to be distinguishable by the processor circuit 28 based on the respective user methods for submitting a web request for the identified web destination 22, as specified by the respective user method identifiers 24′. Hence, the processor circuit 28 determines in step 68 if there is a match (or at least a determined correlation), for the identified destination 22 specified in the generated request 20, between the current user method identifier 24 (representing the most recent method of execution by the user) and any stored user method identifier 24′. If there is no match or any determined correlation (e.g., a partial match) in step 68, the processor circuit 28 causes the corresponding network interface circuit 34 or 48 to output in step 70 the web request 20 or 20′ without the user identifier 38, and to continue user behavior identification training, described below.

However if in step 68 the processor circuit 28 determines a match or a correlation between the current user method 24 and a stored user method identifier 24′ for the same identified web destination 22, the processor circuit 28 can output in step 72 a web request 20 or 20′ for the identified destination 22 with a user identifier 38 for an assigned user having a matching behavior pattern, without the necessity of any server-initiated data structure (e.g., a cookie), and without the necessity of any user login. For example, referring to FIG. 5, if the processor circuit 28 determines that the current user method 24 specifies a bookmark operation for the identified web destination 22 of “www.amazon.com”, the processor circuit 28 can identify the matching network activity entry 64e for the same identified web destination “www.amazon.com” having the matching stored user method identifier 24′ of a bookmark-type user method executed by the user having the user identifier 38 of “User 2”.

FIG. 3 illustrates an example sequence of user inputs (e.g., I1 through I16) 80 by the users of FIG. 1, according to an example embodiment. A shared user device 14 typically will have a period of inactivity 82 between a first time interval 84 when the shared user device is in use by one user (e.g., 14a), and a second time interval 86 when the shared user device is in use by another user (e.g., 14b). Hence, if the processor circuit 28 in the user device 16a and/or the user premises router 46 detects additional inputs (e.g., I5 through I8) 80 following a detected idle interval relative to the network activity entries 64 already stored in the data structure 36 in response to the inputs I1 through I4, the processor circuit 28 can determine and identify that the additional inputs I5 through I8 constitute the beginning of a new user access session. User access sessions can be distinguished not only based on a detected idle interval for a shared user device, but also based on detected inputs supplied via distinct user devices, either during concurrent time intervals or distinct time intervals.

The processor circuit 28 can determine whether the user access sessions are by distinct users based on determining whether any of the user inputs I5 through I8 are requests for any of the same web destinations as already stored for the respective inputs I1 through I4: if there is a correlation in the web destinations accessed in inputs I5 through I8 relative to the web destinations accessed in inputs I1 through I4, and if those matching destinations use the same user method, the processor circuit 28 can conclude that the distinct user sessions are by the same user, and merge the network activity entries, accordingly. Use of web browser navigation buttons to retrieve previously-accessed web destinations (e.g., forward button, back button), or retrieval of a URL from a data structure storing URLs of visited websites (e.g., a “history” file) also can be used to identify that a given user session is by the same user.

Although not illustrated in FIGS. 4 and 5, each network activity entry 64 also can specify a date and/or time of user input, a device identifier, and an instance counter that specifies the number of times that the user accessed the corresponding identified web destination using the same user method, etc.

If the processor circuit determines there is a correlation in matching destinations between the inputs I5 through I8 relative to the web destinations accessed in inputs I1 through I4, and if those matching destinations do not use the same user method, the processor circuit 28 can conclude that the distinct user sessions are by different users, and therefore assign the user identifiers 38 accordingly, resulting in the completion of the initial training interval 100. Similar correlation operations can be performed by the processor circuit 28 for the user access sessions 88 and 90 for the respective inputs I9 through I12 and I13 through I16. In addition, assignment of user access sessions to a given user can be accomplished by the processor circuit 28 detecting a correlation between similar patterns in usage with respect to time of day, day of week, etc. At the very least, however, distinct users can be identified based on determining that one user (e.g., 14a) uses one user method for submitting a web request to an identified web destination, whereas another user (e.g., 14b) uses a distinct user method for submitting a web request to the same identified web destination.

FIGS. 4 and 5 illustrate that the network activity entries 64 can specify various stored user method identifiers 24′ that identify alternative user methods for submitting a web request for an identified web destination 22. Referring to FIG. 5, where the network activity entries 64 are indexed according to the identified web destination 22, the stored user method identifier 24′ for the network activity entry 64a illustrates that the user having the user identifier 38 “User 1” executes the user method for submitting a web request to the identified web destination 22 of “www.amazon.com” based on inputting the text “amazon”. Since the processor circuit 28 can execute a web browser that provides autocomplete operations, network activity entry 64a indicates that the text input of “amazon” as specified in the stored user method identifier 24′ is sufficient for submitting the corresponding web request 20. Hence, it can be appreciated that distinct text values also can be used to distinguish between different users, where the processor circuit 28 can conclude that a complete text input of the domain name “www.amazon.com” distinguishes one user from another user that tends to type only “amazon” as illustrated in the network activity entry 64a, or still another user that simply types only a portion of the domain name in the form of “amaz”, relying on the autocomplete operation to complete the supply of the domain name “www.amazon.com”. Additional distinctions can be provided in text-based user methods based on determining whether a user tends to consistently input (or avoid inputting) the URI scheme (e.g., “http:”, “https:”, “ftp:”, etc.) preceding the hierarchical part of the URI (typically beginning with a double forward slash “//”).

Hence, the stored user method identifiers 24′ for the network activity entries 64a, 64b, 64d, and 64i illustrate user methods executed by manual user input of at least a portion of the identified web destination. The stored user method identifiers 24′ for the network activity entries 64c, 64e, and 64f illustrate that the user method is executed by the corresponding identified user 38 based on retrieval of the identified web destination 22 from the bookmark file 52. Hence, the users “User 1” and “User 2” can be distinguished between web request for the identified web destinations “www.amazon.com” or “www.foxnews.com”, since the user “User 1” executes the user method of text input for both web destinations, whereas the user “User 2” executes the user method of bookmark retrieval for both web destinations.

The stored user method identifiers 24′ for the network activity entries 64g, 64h, 64j, and 64k also illustrate execution of a user method for an identified web destination 22 based on a user selection of the identified web destination from a web page presented by the user device. In particular, the stored user method identifiers 24′ for each of the network activity entries 64g, 64h, 64j, and 64k reference the identified web destination 22 within the user method identifier 24′ using the reference character “X”, preceded by an identification of one or more websites referenced by a user. Hence, the entry 64g illustrates that “User 2” submitted the web request for the web destination “www.schoolnotes.com” based on first submitting a search query (“school notes”) using a prescribed search service (e.g., “Yahoo Search”), where the resulting search result display to the user presented the URL to the chosen destination “www.schoolnotes.com”.

In contrast, the network activity entries 64j, 64k, and 64h illustrate a sequence of web request identifiers specifying respective web pages that were presented to the user “User 3”, and representing a contiguous sequence of web pages requested by the user “User 3”. For example, the network activity entry 64i illustrates the manual text input of the destination “schoolnotes.com”: the reference in the network activity entries 64h, 64j, and 64k to “URL1” represents the URL “www.schoolnotes.com”; the reference in the network activity entries 64h and 64k to “URL2” represents the URL “www.schoolnotes.com/teacher1”; the reference in the network activity entry 64h to “URL3” represents the URL “www.schoolnotes.com/teacher3”. Hence, the network activity entries 64i, 64j, 64k, and 64h illustrate that the user “User 3” tends to access the respective websites according to the contiguous sequence of “www.schoolnotes.com” (manually input), then “www.schoolnotes.com/teacher1” (based on selecting a hyperlink on the web page “www.schoolnotes.com”), then “www.schoolnotes.com/teacher2” (based on selecting a hyperlink on the web page “www.schoolnotes.com/teacher1”), then “www.discovery.com” (based on selecting a hyperlink on the web page “www.schoolnotes.com/teacher2”).

Hence, in response to receiving a web request 20 for the identified web destination 22 of “www.discovery.com”, the processor circuit 28 can distinguish between the user “User 1” and the user “User 3” based on determining, from the network activity entries 64b and 64h that the user “User 1” executes a manual text input, whereas the user “User 3” executes the user method based on navigating a sequence of multiple web pages starting with the web page “www.schoolnotes.com”. Similarly, in response to receiving a web request 20 for the identified web destination 22 of “www.schoolnotes.com”, the processor circuit 28 can distinguish between the user “User 2” and “User 3” based on the distinct user method identifiers 24′ specified in the network activity entries 64g and 64i.

According to example embodiments, users can be automatically identified, without the necessity of any user login operation or any data structures generated by any web destination (e.g., cookies), based on distinguishing users based on the user method executed by a user for submitting a web request for an identified web destination.

It will be appreciated that different variations can be applied within the example embodiments. For example, a network activity entry can specify multiple user method identifiers having respective probability distributions, in cases where a user applies different user methods; for example, a given network activity entry can specify for the corresponding identified web destination that the identified user uses text input 75 percent of the time, and bookmark retrieval 25 percent of the time; alternately, the user method identifier can specify the most likely user method, and disregard variations by the user that are not statistically significant. In addition, the processor circuit 28 can continually update the network activity entries over time to accommodate for changes in user habits. Further, the identification of a web destination in a network activity entry can be expanded to encompass a prescribed web domain or subdomain in order to accommodate dynamically generated web pages by a given website: hence, dynamically generated URLs specifying the same web domain or subdomain can be deemed as identifying the same identified web destination despite each URL having a distinct session identifier in the URL string. In addition, the user method for submitting a web request can be initiated by the processor circuit 28 in the user device 16 utilizing executable resources other than a web browser, for example an executable application (e.g., e-mail application, word processor application, etc.) submitting a web request in response to the user selecting a URL embedded within a data structure stored on the user device (e.g., an e-mail message, a word processing document, etc.).

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
detecting, by an apparatus at a user premises, a user method executed by a user at the user premises for submitting a web request for an identified web destination, the user method being one of a plurality of available user methods for submitting the web request;
associating, by the apparatus, the user method with the identified web destination specified in the web request; and
outputting, by the apparatus, the web request with at least one of a user method identifier specifying the corresponding user method or a user identifier that identifies the user independent of any data structure received from any web destination.

2. The method of claim 1, wherein the user identifier identifies the user independent of any login procedure by the user.

3. The method of claim 1, wherein:
the apparatus is implemented as a user device configured for receiving inputs from the user via a user input interface circuit;
the plurality of available user methods including a manual user input by the user of at least a portion of the identified web destination, a retrieval by the user of the identified web destination from a data structure stored on the user device, and a user selection of the identified web destination from a web page presented by the user device;
the detecting including generating the user method identifier specifying the user method.

4. The method of claim 3, wherein the outputting includes outputting the web request with the user method identifier to a network device, for collection of the user method identifier as a user behavior indicator of the user toward the identified web destination.

5. The method of claim 3, wherein the user method identifier specifies a sequence of web request identifiers specifying respective web pages presented to the user, the sequence of web request identifiers and the identified web destination representing a contiguous sequence of web pages requested by the user.

6. The method of claim 3, further comprising the apparatus accumulating a plurality of web requests and respective user method identifiers, for identification of a determined behavior pattern toward respective identified web destinations by the user, and identification of a second determined behavior pattern toward at least one of the respective identified web destinations by a second user.

7. The method of claim 6, further comprising the apparatus identifying the user as distinct from the second user based on a determined correlation between the user method for requesting the identified web destination and a corresponding stored user method for the identified web destination in the determined behavior pattern, the outputting including outputting the web request with the user identifier that identifies the user based on the determined correlation.

8. The method of claim 1, wherein:
the apparatus is implemented as a router at the user premises, the detecting the user method including receiving the web request and the user method identifier from a user device having generated the user method identifier relative to the web request;
the plurality of available user methods including a manual user input by the user of at least a portion of the identified web destination, a retrieval by the user of the identified web destination from a data structure stored on the user device, and a user selection of the identified web destination from a web page presented by the user device;
the associating including storing the web request for the identified web destination and the corresponding user method identifier in a network activity entry;
the method further comprising the apparatus accumulating a plurality of web requests and respective user method identifiers at the user premises in respective network activity entries, for identification of a determined behavior pattern toward respective identified web destinations by the user, and identification of a second determined behavior pattern toward at least one of the respective identified web destinations by a second user.

9. The method of claim 8, further comprising the apparatus identifying the user as distinct from the second user based on a determined correlation between the user method for requesting the identified web destination and a corresponding stored user method for the identified web destination in the determined behavior pattern, the outputting including outputting the web request with the user identifier that identifies the user based on the determined correlation to the identified web destination via a wide area network.

10. The method of claim 8, wherein the user method identifier specifies a sequence of web request identifiers specifying respective web pages presented to the user and detected by the user device, the sequence of web request identifiers and the identified web destination representing a contiguous sequence of web pages requested by the user.

11. The method of claim 1, further comprising the apparatus identifying the user as distinct from a second user, having submitted a second web request for the identified web destination via the apparatus, based on a determined correlation between the user method for requesting the identified web destination and a corresponding stored user method for the identified web destination and assigned to the user, the outputting including outputting the web request with the user identifier that identifies the user based on the determined correlation.

12. An apparatus comprising:
a device interface circuit configured for detecting a user method executed by a user at a user premises for submitting a web request for an identified web destination, the user method being one of a plurality of available user methods for submitting the web request; and
a processor circuit configured for associating the user method with the identified web destination specified in the web request, the processor circuit configured for outputting, via the device interface circuit, the web request with at least one of a user method identifier specifying the corresponding user method or a user identifier that identifies the user independent of any data structure received from any web destination, the apparatus implemented at the user premises.

13. The apparatus of claim 12, wherein the user identifier identifies the user independent of any login procedure by the user.

14. The apparatus of claim 12, wherein:
the apparatus is implemented as a user device, the device interface circuit including a user input interface circuit configured for receiving inputs from the user;
the plurality of available user methods including a manual user input by the user of at least a portion of the identified web destination, a retrieval by the user of the identified web destination from a data structure stored on the user device, and a user selection of the identified web destination from a web page presented by the user device;
the processor circuit configured for generating the user method identifier specifying the user method.

15. The apparatus of claim 14, wherein the device interface circuit is configured for outputting the web request with the user method identifier to a network device, for collection of the user method identifier as a user behavior indicator of the user toward the identified web destination.

16. The apparatus of claim 14, wherein the processor circuit is configured for adding to the user method identifier a sequence of web request identifiers specifying respective web pages presented to the user and detected by the processor circuit, the sequence of web request identifiers and the identified web destination representing a contiguous sequence of web pages requested by the user.

17. The apparatus of claim 14, wherein the processor circuit is configured for accumulating a plurality of web requests and respective user method identifiers, for identification of a determined behavior pattern toward respective identified web destinations by the user, and identification of a second determined behavior pattern toward at least one of the respective identified web destinations by a second user.

18. The apparatus of claim 17, wherein the processor circuit is configured for identifying the user as distinct from the second user based on a determined correlation by the processor circuit between the user method for requesting the identified web destination and a corresponding stored user method for the identified web destination in the determined behavior pattern, the device interface circuit configured for outputting the web request with the user identifier that identifies the user based on the determined correlation by the processor circuit.

19. The apparatus of claim 12, wherein:
the apparatus is implemented as a router at the user premises, device interface circuit configured for receiving the web request and the user method identifier from a user device having generated the user method identifier relative to the web request;
the plurality of available user methods including a manual user input by the user of at least a portion of the identified web destination, a retrieval by the user of the identified web destination from a data structure stored on the user device, and a user selection of the identified web destination from a web page presented by the user device;
the processor circuit configured for associating the user method with the identified web destination based on storing the web request for the identified web destination and the corresponding user method identifier in a network activity entry;
the processor circuit further configured for accumulating a plurality of web requests and respective user method identifiers at the user premises in respective network activity entries, for identification of a determined behavior pattern toward respective identified web destinations by the user, and identification of a second determined behavior pattern toward at least one of the respective identified web destinations by a second user.

20. The apparatus of claim 19, wherein the processor circuit is configured for identifying the user as distinct from the second user based on a determined correlation by the processor circuit between the user method for requesting the identified web destination and a corresponding stored user method for the identified web destination in the determined behavior pattern, the device interface circuit configured for outputting the web request with the user identifier that identifies the user based on the determined correlation to the identified web destination via a wide area network.

21. The apparatus of claim 19, wherein the user method identifier specifies a sequence of web request identifiers specifying respective web pages presented to the user and detected by the user device, the sequence of web request identifiers and the identified web destination representing a contiguous sequence of web pages requested by the user.

22. The apparatus of claim 12, wherein the processor circuit is configured for identifying the user as distinct from a second user, having submitted a second web request for the identified web destination via the apparatus, based on a determined correlation between the user method for requesting the identified web destination and a corresponding stored user method for the identified web destination and assigned to the user, the processor circuit configured for outputting, via the device interface circuit, the web request with the user identifier that identifies the user based on the determined correlation.

23. An apparatus comprising:
a device interface circuit configured for detecting a user input associated with a user method executed by a user at a user premises for submitting a web request for an identified web destination, the user method being one of a plurality of available user methods for submitting the web request; and
means for associating the user method with the identified web destination specified in the web request, the means for associating configured for outputting, via the device interface circuit, the web request with at least one of a user method identifier specifying the corresponding user method or a user identifier that identifies the user independent of any data structure received from any web destination, the apparatus implemented at the user premises.

24. Logic encoded in one or more tangible media for execution and when executed operable for:
detecting, by an apparatus executing the logic at a user premises, a user method executed by a user at the user premises for submitting a web request for an identified web destination, the user method being one of a plurality of available user methods for submitting the web request; and
associating, by the apparatus, the user method with the identified web destination specified in the web request; and
outputting, by the apparatus, the web request with at least one of a user method identifier specifying the corresponding user method or a user identifier that identifies the user independent of any data structure received from any web destination.
